(19) United States
(12) Patent Application Publication
(10) Pub. No.: US 2022/0204131 A1
(43) Pub. Date: Jun. 30, 2022

(54) ELECTRIC BICYCLE

(71) Applicant: TEXA DYNAMICS S.R.L., Monastier di Treviso (IT)

(72) Inventor: Bruno VIANELLO, Monastier di Treviso (IT)

(21) Appl. No.: 17/611,216

(22) PCT Filed: May 13, 2020
(86) PCT No.: PCT/IB2020/054508

§ 371 Date: Nov. 15, 2021

(30) Foreign Application Priority Data
May 13, 2019 (IT) 102019000006755

(51) Int. Cl. B62M 6/55; B62M 6/50

(52) U.S. Cl. CPC B62M 6/55; B62M 6/50

(57) ABSTRACT

An electric bicycle is described with a propulsion unit comprising two pedals, an electric motor to assist pedaling, a first driving toothed wheel connected by a free-wheel to the pedals, and a second driving toothed wheel which is coaxial with the first toothed wheel and connected to the motor to receive rotary torque therefrom, Two chains transfer driving torque from the first and second toothed wheel to two gears of a wheel of the bicycle.

An electronic circuit controls electrical power generated by the electric motor, and preferably stores it into the battery.

The present invention relates to an electric bicycle.

An electric-powered bicycle has an electric motor to assist pedaling. To supply the motor it is equipped with a battery, which of course has a charge limit whereby the assisted mileage is limited.

To answer the problem, e.g. EP 1457414 proposes an electric bicycle in which during braking electrical energy is regeneratively recovered and the battery is charged. Two chains and a special clutch are used to connect the rear wheel to the motor when the latter functions as a dynamo.

EP 1457414 has a complex, bulky and heavy structure.

The main object of the invention is to improve the present state of the art.

Another object of the invention is to create an improved electric bicycle capable of recovering electrical energy to recharge an on-board battery.

These and other objects are achieved by what is reported in the attached claims; advantageous technical characteristics are defined in the dependent claims.

An electric bicycle is proposed comprising:
a propulsion unit comprising
   two pedals,
   an electric motor to assist pedaling,
   a first driving toothed wheel connected by means of a freewheel to the pedals,
   a second driving toothed wheel which is coaxial with the first toothed wheel and connected to the motor to receive driving torque,
a first chain for transferring driving torque from the first toothed wheel to a first pinion or gear of a wheel of the bicycle,
a second chain for connecting the second toothed wheel and a second pinion or gear rotationally integral with the wheel,
a battery to supply the electric motor,
an electronic (e.g. microprocessor-based) circuit to control electrical power generated by the electric motor, and preferably store it in the battery.

It should be noted that the coaxiality between the first and second driving toothed wheel gives compactness to the motor unit.

The second chain may serve to brake the wheel when the bicycle runs downhill.

According to a preferred embodiment, the first toothed wheel has a diameter different from the second toothed wheel's, in particular the second toothed wheel has a smaller diameter than that of the first toothed wheel. Even more preferably, the second toothed wheel has a smaller diameter than the second gear or pinion.

Thus the motor's rpm are raised by the transmission ratio between the second toothed wheel and the second gear, improving the performance of the bicycle. In fact the motors commonly used in electric bicycles, in particular axial-flow motors, have not brilliant low-speed performance.

E.g. the transmission ratio between the second toothed wheel and the second gear is 3:1 to 6:1, e.g. 5:1.

According to a preferred embodiment, the first and second chains are arranged on the same side of the bicycle, with the advantage of reducing the volume occupied by the chains and giving less hindrance to the rider's legs.

According to a preferred embodiment, the first and second chains are arranged on opposite sides of the bicycle, or on opposite sides of the wheel, with the advantage of obtaining more space on the wheel hub for e.g. fitting a sprocket pack of the shifter with or without derailleur. According to a more preferred embodiment, the first gear comprises or consists of a gear-shift sprocket set.

The electronic circuit that controls the electrical power generated by the motor may have various operating logics. E.g. either it brakes the bicycle downhill and recovers simultaneously energy by storing it in the battery or it brakes the bicycle downhill by dissipating all the energy generated by the motor.

According to a preferred embodiment, the bicycle comprises

a first speed sensor,

a second sensor to detect the downhill-motion state of the bicycle,

and the electronic circuit is configured for
detecting the downhill-motion state of the bicycle via the second sensor,
detecting the bicycle speed through the first sensor,
controlling the electric motor so that it acts as an electric generator converting mechanical energy received through the second chain.

In a variant, the first and second sensors may coincide.

According to a preferred embodiment, the second driving toothed wheel is selectively connectable to the first toothed wheel by means of a clutch or a joint, in particular a clutch or a joint whose engaged/disengaged state can be controlled by the electronic circuit.

According to a preferred embodiment, the electronic circuit is configured for implementing an anti-theft device. It is indeed advantageous to take advantage of the fact that the second chain can always be connected to the motor, e.g. by means of said clutch or joint. Thus, the electronic circuit is configured for

detecting the state of prolonged stop of the bicycle by means of a sensor or a command of a user,

and in case of a prolonged stop, controlling the electric motor so that it acts as an electric generator to generate on the second chain a torque opposing to the bike motion, e.g. by shorting an electric winding of the motor (via e.g. a relay or controlled switch).

Further advantages will become clear from the following description, which refers to a preferred embodiment of a bicycle in which:

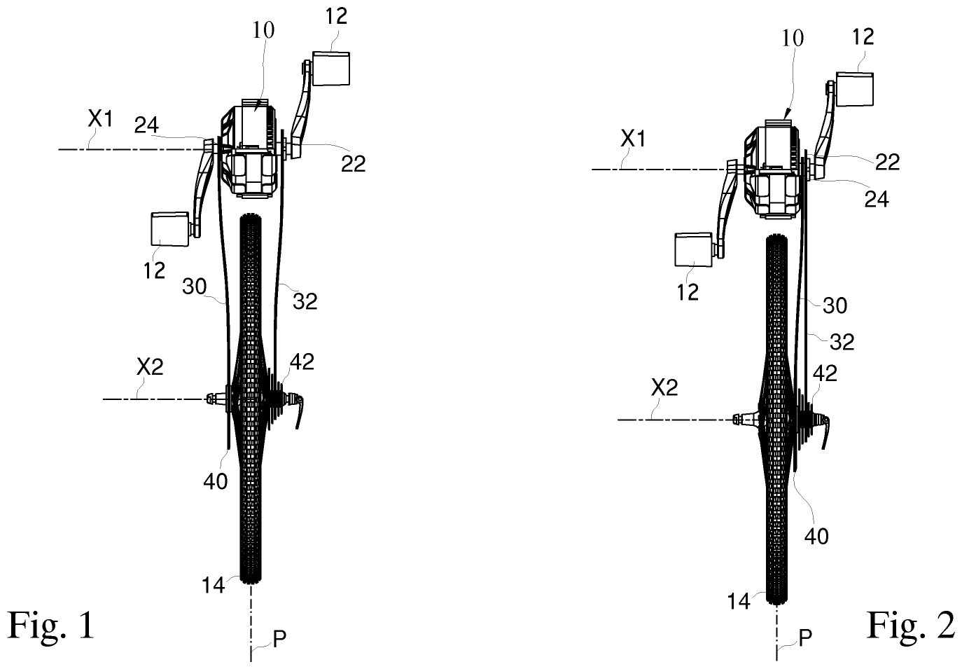

FIG. 1 shows a top view of components of an electric bicycle;

FIG. 2 shows a top view of components of a second electric bicycle.

Equal numbers in the figures indicate equal or substantially equal parts.

FIG. 1 shows a first variant of motorization for an electric bicycle (not shown).

The propulsion of the bicycle is ensured by a propulsion unit 10 from which two pedals 12 come out and which houses an electric motor to assist pedaling.

The pedals 12 and the electric motor have independent and coaxial shafts arranged along an axis. X1

The pedals 12 are connected to a toothed wheel 22 by means of a free-wheel, while the motor shaft is connected—or selectively connectable via a clutch or joint—to a second toothed wheel 24.

The toothed wheel 24 is engaged with a chain 30 to transfer or receive torque to/from a pinion 40 of a wheel 14 of the bicycle, rotatable about an axis X2 parallel to the axis X1. The pinion 40 is always rotationally integral with the wheel 14.

A second chain 32 connects the toothed wheel 22 to a pinion assembly 42 of the shift gearbox mounted on the opposite side of the wheel 14 with respect to the pinion 40. The chain 32 transfers muscle force from the pedals 12 to the group 42 and is movable on the pinion assembly 42 by a derailleur (not shown). Optionally the pinion assembly 42 may consist of a single pinion.

As can be seen from FIG. 1, the chains 30, 32 are placed on opposite sides with respect to an imaginary plane on which the wheel 14 lies (a plane P orthogonal to the axis X1 and X2). This allows the comfortable assembly of the pinion assembly 42, which can optionally be also consisting of a single pinion, or of one group provided with many pinions.

FIG. 2 shows a second motorization variant.

This time the chains 30, 32 are placed on the same side with respect to an imaginary plane on which the wheel 14 lies (a plane orthogonal to the axis X1 and X2). This allows to limit the overall bulk of the chains 30, 32, e.g. for the ankles of the rider.

For the two variants, there is also a battery (not shown) to supply the electric motor.

An electronic circuit (not shown) controls the operation of the motor both when it delivers power to assist pedaling, and when it is used as electric power generator while the bicycle runs downhill. The generated energy can be stored in whole or in part in the battery, according to the control of the electronic circuit on the energy flow delivered by the motor.

The electronic circuit is configured to regulate the energy recovery and/or to brake the bicycle running downhill, e.g. by dissipating the energy without sending it to the battery. All the operating combinations are possible.

1. Electric bicycle comprising:
a propulsion unit comprising
two pedals
an electric motor to assist pedaling,
a first driving toothed wheel connected by a free-wheel to the pedals,
a second driving toothed wheel which is coaxial with the first toothed wheel and connected to the motor to receive rotary torque therefrom,
a first chain for transferring driving torque from the first toothed wheel to a first pinion of a wheel of the bicycle,
a second chain for connecting the second toothed wheel and a second pinion rotatably integral with the wheel,
a battery to power the electric motor,
an electronic circuit for
controlling electrical power generated by the electric motor, and preferably
storing it into the battery.

2. Electric bicycle as claimed in claim 1 or 11 or 12, wherein the first toothed wheel has a diameter different from that of the second toothed wheel.

3. Electric bicycle according to claim 1 or 11 or 12, wherein the second toothed wheel has a diameter smaller than that of the first toothed wheel.

4. Electric bicycle according to claim 1 or 11 or 12, wherein the second toothed wheel has a diameter smaller than that of the second gear.

5. Electric bicycle according to claim 4, wherein the transmission ratio between the second toothed wheel and the second gear is 3:1 to 6:1, e.g. 5:1.

6. (canceled)

7. (canceled)

8. (canceled)

9. (canceled)

10. (canceled)

11. Electric bicycle according to claim 1, wherein the first and second chains are arranged on the same side of the bicycle.

12. Electric bicycle according to claim 1, wherein the first and second chains are arranged on opposite sides of the bicycle.

13. Electric bicycle according to claim 1 or 11 or 12, comprising:
a first speed sensor,
a second sensor for detecting the state of downhill motion of the bicycle, and
the electronic circuit is configured for detecting the state of downhill motion of the bicycle via the second sensor,
detecting the speed of the bicycle via the first sensor, controlling the electric motor so that it behaves like an electric generator by converting mechanical energy received through the second chain.

14. Electric bicycle according to claim 1 or 11 or 12, wherein the second driving toothed wheel is selectively connectable to the first toothed wheel by means of a clutch or a joint.

15. Electric bicycle according to claim 1 or 11 or 12, wherein the electronic circuit is configured for detecting the state of prolonged stop of the bicycle by means of a sensor or a command from a user,
and if there is a prolonged stop,
controlling the electric motor so that it behaves like an electric generator to generate on the second chain a torque opposing to the motion of the bicycle.

16. Electric bicycle according to claim 13, wherein the second driving toothed wheel is selectively connectable to the first toothed wheel by means of a clutch or a joint.

17. Electric bicycle according to claim 13, wherein the electronic circuit is configured for
detecting the state of prolonged stop of the bicycle by means of a sensor or a command from a user,
and if there is a prolonged stop,
controlling the electric motor so that it behaves like an electric generator to generate on the second chain a torque opposing to the motion of the bicycle.

18. Electric bicycle according to claim 14, comprising:
a first speed sensor,
a second sensor for detecting the state of downhill motion of the bicycle, and
the electronic circuit is configured for
detecting the state of downhill motion of the bicycle via the second sensor,
detecting the speed of the bicycle via the first sensor,
controlling the electric motor so that it behaves like an electric generator by converting mechanical energy received through the second chain.

19. Electric bicycle according to claim 14, wherein the electronic circuit is configured for
detecting the state of prolonged stop of the bicycle by means of a sensor or a command from a user,
and if there is a prolonged stop,
controlling the electric motor so that it behaves like an electric generator to generate on the second chain a torque opposing to the motion of the bicycle.

20. Electric bicycle according to claim 15, comprising:
a first speed sensor,
a second sensor for detecting the state of downhill motion of the bicycle, and
the electronic circuit is configured for
detecting the state of downhill motion of the bicycle via the second sensor,
detecting the speed of the bicycle via the first sensor,
controlling the electric motor so that it behaves like an electric generator by converting mechanical energy received through the second chain.

21. Electric bicycle according to claim 15, wherein the second driving toothed wheel is selectively connectable to the first toothed wheel by means of a clutch or a joint.
